(19) United States
(12) Patent Application Publication
(10) Pub. No.: US 2014/0366015 A1
(43) Pub. Date: Dec. 11, 2014

(54) METHOD AND SYSTEM FOR COMBINING MULTIPLE APPLICATIONS INTO A SINGLE BINARY FILE WHILE MAINTAINING PER PROCESS SANDBOXING

(71) Applicant: OpenPeak Inc., Boca Raton, FL (US)

(72) Inventors: Andrew James Dobson, Wellington, FL (US); David Medina, Miami, FL (US)

(21) Appl. No.: 14/291,966

(22) Filed: May 30, 2014

Related U.S. Application Data
(60) Provisional application No. 61/829,542, filed on May 31, 2013.

(51) Int. Cl. G06F 9/445; G06F 21/53

(52) U.S. Cl. CPC G06F 8/61; G06F 21/53
USPC 717/177; 717/174

(57) ABSTRACT

A method and system for combining multiple applications into a single binary file while maintaining per process sandboxing are described herein. The method can include the steps of identifying a plurality of applications for delivery to a computing device and analyzing the non-code assets of the identified applications for conflicts. The conflicts among the non-code assets of the identified applications can be resolved. In addition, a process tag can be attached to the components of the identified applications to ensure that the components of the identified application run in their authorized processes, thereby maintaining per process sandboxing of the identified applications. The plurality of applications can be packaged as a single binary file without affecting the per process sandboxing.

### CROSS-REFERENCE TO RELATED APPLICATIONS

This patent application claims priority to U.S. Provisional Patent Application No. 61/829,542, filed on May 31, 2013, which is incorporated herein by reference in its entirety.

### FIELD OF TECHNOLOGY

The present description relates to systems and methods for the delivery of applications to a portable computing device and more particularly, for the delivery of multiple applications as a single binary without affecting per process sandboxing.

### BACKGROUND

A recent development in wireless technology is the deployment of mobile devices that are provisioned to support the installation of secure applications. Such secure applications may permit a user to access sensitive enterprise data and to enable the selective enforcement of corporate policies against the secure applications themselves or the mobile device. In some cases, a suite of secure applications that are part of a personal information manager (PIM) may be delivered to the mobile device. These secure applications typically deal with information that is useful for conducting tasks associated with an enterprise or organization, like creating and maintaining contact lists, calendar entries and email management.

Up to this point, the secure applications of the PIM, while part of a bundle, have been delivered to the mobile device on an individual basis. This process is quite tedious and time-consuming, especially considering that 12-15 different secure applications may be involved. Moreover, there are numerous interdependencies among these secure applications, each of which must be maintained, which makes the delivery and installation of these applications even more difficult.

### SUMMARY

A method for combining multiple applications into a single binary file while maintaining per process sandboxing is described herein. The method can include the steps of identifying a plurality of applications to be part of the single binary file and analyzing the non-code assets of the identified applications for conflicts. The method can also include the step of resolving the conflicts among the non-code assets of the identified applications. One or more process tags can be attached to the components of the identified applications to ensure that the components of the identified application run in their authorized processes, thereby maintaining per process sandboxing of the identified applications. In addition, the plurality of applications can be packaged as the single binary file without affecting the per process sandboxing.

As an example, the single binary file can be a secure personal information manager application. In addition, resolving the conflicts among the non-code assets of the identified applications may include renaming resources of the identified applications that present the conflicts. Renaming the resources of the identified applications that present the conflicts may include renaming the resources based on a package index that is assigned to the identified applications.

The method may also include the steps of scanning the identified applications for references to the renamed resources and modifying the references to the renamed resources to account for the renaming of the resources. In another embodiment, the method may also include the steps of determining whether the identified applications of the single binary file contain code that is common to more than one of the identified applications and deleting the code that is common to the identified applications of the single binary file. The single binary file may be distributed to one or more computing devices such that an operating system of the computing device treats the single binary file as a single application that supports multiple processes. As another example, the single binary file may be distributed to an application repository such that the single binary file is uploaded to the application repository as a single application.

A method of creating a personal information manager application is also described herein. This method can include the steps of identifying a plurality of applications to be part of the personal information manager application and packaging the identified applications as a single binary file that serves as the personal information manager application while maintaining per process sandboxing of the identified applications. In one embodiment, this method can also include the steps of analyzing the identified application for conflicts and resolving the conflicts between the identified applications. In another embodiment, the method can include the step of attaching process tags to the components of the identified applications to ensure that the components of the identified applications run in their authorized processes.

As an example, the personal information manager application can be a secure personal information manager application and non-secure applications are restricted from accessing the secure personal information manager application. As another example, the identified applications that are to be part of the personal information manager application are secure applications. The method may also include the step of decompiling the identified applications to enable the analyzing of the identified applications, the resolving of the conflicts and the attachment of the process tags of the components of the identified applications. Moreover, attaching the process tags to the components of the identified applications may avoid interference with any processes that may run a plurality of the identified applications of the single binary file.

A system for combining multiple applications into a single binary file while maintaining per process sandboxing is also described herein. The system can include an input mechanism that is configured to receive the identities of multiple applications and a conflicts engine that is configured to resolve conflicts among the identified applications. The system may also have a process engine that is configured to assign process tags to the components of the identified applications such that the components of the identified applications run in their authorized processes. A compiler may also be part of the system, and the compiler is configured for packaging the applications as a single binary file without affecting the per process sandboxing.

As an example, the single binary file can be a personal information manager application. As another example, personal information manager application is a secure personal information manager application and non-secure applications are restricted from accessing the secure personal information manager application.

In one embodiment, the compiler may be further configured to generate a resource file for the single binary file to account for the conflict resolution. The compiler may be further configured to generate a manifest file for the single binary file to identify the components of the single binary file and to group the components together according to the assigned processes of the components. In another arrangement, the conflicts engine can be configured to resolve conflicts among non-code assets of the identified applications.

A method of executing a personal information manager application is also described herein. This method can include the steps of receiving—at a computing device—a single binary file that is a personal information manager application and is comprised of multiple individual applications and installing the personal information manager application on the computing device. The method can also include the step of executing the personal information manager application, wherein an operating system of the computing device treats the personal information manager application as a single application. During the execution of the personal information manager application, per process sandboxing of the individual applications of the personal information manager application is maintained.

A computing device is also described herein. The computing device can include an interface that can be configured to receive a single binary file that is a personal information manager application and that is comprised of multiple individual applications. The computing device can also include a processing unit that can be configured to cause the personal information manager application to be executed on the computing device. An operating system may also be installed on the computing device, and the operating system may treat the personal information manager application as a single application when the personal information manager application is executed. During the execution of the personal information manager application, the processing unit can cause the per process sandboxing of the individual application of the personal information manager application to be maintained.

Further features and advantages, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for combining multiple applications into a single binary file while maintaining per process sandboxing.

FIG. 2 illustrates an example of a method for combining multiple applications into a single binary file while maintaining per process sandboxing.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “computer program medium” and “computer readable medium” are defined as one or more components that are configured to store instructions that are to be executed by a processing unit or some other component.

An “application” is defined as a program or programs that perform one or more particular tasks on a computing device. Examples of an application include programs that may present a user interface for interaction with a user or that may run in the background of an operating environment and that may not present a user interface while in the background. The term “secure application” is defined as an application that has been modified from its conventional form to restrict communication between the application and unauthorized programs or devices, restrict operation of the application based on policy or to alter, augment or add features associated with the operation of the application. A “non-secure application,” conversely, is defined as an application that has not been converted to a secure application. The term “operating system” is defined as a collection of software components that directs a computing device's operations, including controlling and scheduling the execution of other programs and managing storage, input/output and communication resources.

A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. An “interface” is defined as a component or a group of components that enable(s) a device to communicate with one or more different devices, whether through hard-wired connections, wireless connections or a combination of both. A “transceiver” is defined as a component or a group of components that transmit signals, receive signals or transmit and receive signals, whether wirelessly or through a hard-wired connection or both. The word “among” is not necessarily meant to convey an association or relationship among three or more units or elements, irrespective of any particular grammar rule. Similarly, the word “between” is not intended to limit any particular arrangement to two units or elements.

As explained earlier, many mobile devices have the ability to install secure applications, some of which may be part of a secure PIM. There may be a significant number of PIM applications, and current techniques call for the individual download and installation of each of these application. A further complication in this process is the requirement to maintain all the interdependencies of the PIM applications.

As a solution, a method and system for combining multiple applications into a single binary file while maintaining per process sandboxing are presented here. The method can include the steps of identifying a plurality of applications for delivery to a computing device and analyzing the non-code assets of the identified applications for conflicts. The conflicts among the non-code assets of the identified applications can be resolved. In addition, a process tag can be attached to the components of the identified applications to ensure that the components of the identified application run in their authorized processes, thereby maintaining per process sandboxing of the identified applications. The plurality of applications can be packaged as a single binary file without affecting the per process sandboxing.

Thus, multiple applications, such as secure PIM applications, can be combined into a single binary file for delivery, installation and maintenance purposes. This configuration presents significant improvements over attempting to deliver multiple applications on an individual basis. Moreover, because per process sandboxing is maintained for the single binary file, it can be ensured that an issue with one application that is part of the binary does not interfere with the operation of another application that is part of the binary.

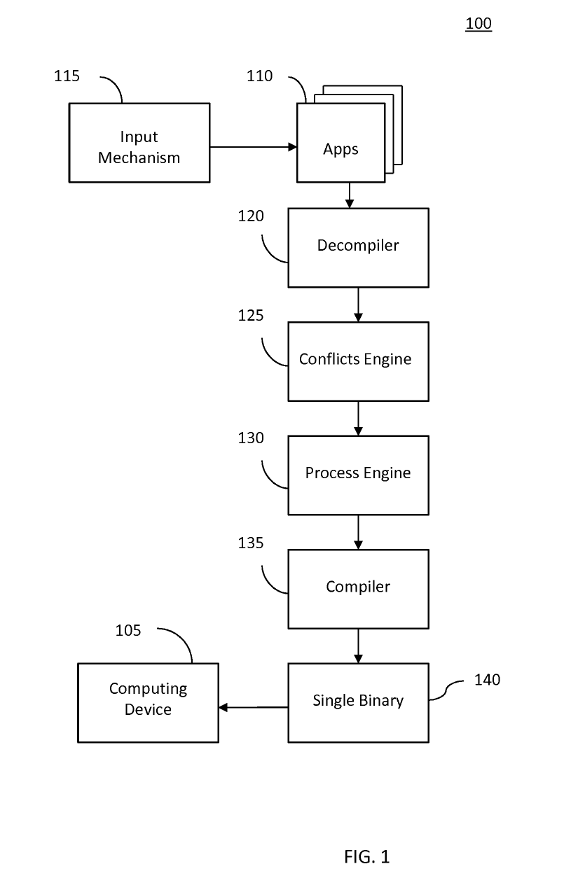

Referring to FIG. 1, a system 100 that can facilitate the principles described herein is shown. In one arrangement, the system 100 can include a computing device 105 that is capable of downloading and installing any suitable number of applications 110. Some of these applications 110 may be secure applications, which are conventional applications that have been modified to support the policies and protect the data of an enterprise or organization that has some association with the user of the system 100. For example, a secure application may be configured to encrypt data that it writes to storage or to block certain features based on a current location in which the system 100 is operating. As another example, through namespace enforcement and other techniques, non-secure applications may be restricted from exchanging data with or otherwise accessing the secure applications installed on the device. Additional information on this arrangement, including how secure applications may be created, can be found in U.S. Pat. No. 8,695,060, issued on Apr. 8, 2014, which is incorporated by reference herein in its entirety.

Some of the secure applications 110 may be tabbed as being part of a secure PIM for delivery to the computing device 105. The system 100 can include an input mechanism 115 to allow for the selection of any number of secure applications 110 for this purpose. The input mechanism 115 can be any component or group of components to enable such selection. In addition, the system 100 can include a decompiler 120 for decompiling the selected applications 110 and a conflicts engine 125, which can identify certain conflicts among the selected applications 110. A process engine 130 can assign process tags to the components of the applications 110 to ensure that the components run in their authorized processes. The system 100 can also include a compiler 135, which can package the selected applications 110 into a single binary file 140, for delivery to the computing device 105 or some other suitable device.

Each of the computing device 105, the input mechanism 115, the decompiler 120, the conflicts engine 125, the process engine 130 and the compiler 135 may include any suitable combination of software and hardware or circuitry to carry out the processes described above. Moreover, any and each of these components may be combined to form a single device, as opposed to individual devices. For example, in one arrangement, the compiler 135 and the decompiler 120 may be combined as a single device that can be configured to compile and decompile any suitable code.

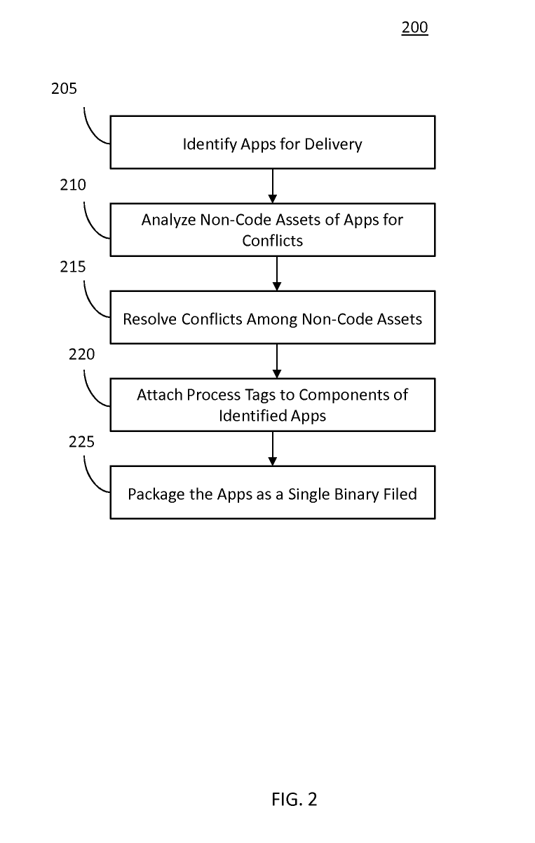

Referring to FIG. 2, an example of a method 200 for illustrating the principles described herein is shown. It is important to note that the method 200 may include additional or even fewer steps or processes in comparison to what is illustrated in FIG. 2. Moreover, the method 200 is not necessarily limited to the chronological order that is shown in FIG. 2. In describing the method 200, reference may be made to FIG. 1, although it is understood that the method 200 may be practiced with any other suitable systems and components.

At step 205, applications may be identified for delivery to a computing device, and at step 210, the non-code assets of the identified applications can be analyzed for conflicts. At step 215, any conflicts among the non-code assets may be resolved.

For example, one or more applications 110, which may be secure applications 110, can be identified for delivery to the computing device 105, such as through the input mechanism 115. The identified applications 110 may be selected as part of a secure PIM to be sent to the computing device 105. It is understood, however, that the techniques presented here are not limited to secure applications or to applications that are to be part of a PIM (secure or non-secure), as the principles herein may apply to any suitable grouping of applications 110.

Once identified, the decompiler 120 can decompile the applications 110 into a more suitable format for processing in accordance with the techniques described below. In one non-limiting example, each of the identified applications 110 may be converted from a .dex file to a smali format. Once in the acceptable format, the conflicts engine 125 can analyze the non-code assets of the identified applications 110 in an effort to find conflicts. For example, the non-code assets may be the resources of the identified applications 110, and the resources may be identified through a resource file, which is a class that contains the definitions for the resources of an application. Suitable examples of the resources include audio files and images and other things related to the visual presentation of the applications 110. The conflicts engine 125 can conduct the analysis through a process of string comparisons, although any other suitable technique may be employed.

If the conflicts engine 125 identifies any conflicts, then these conflicts may be resolved, such as by renaming the resources of the affected applications 110. Consider the following example. A first identified application 110 may include a .png file named “img.png,” while a second identified application 110 may include an identically-named .png file. To resolve this conflict, the .png file for the second identified application 110 can be renamed to “img_{—}1.png,” while the name of the resource for the first identified application 110 can remain the same, “img.png.” If a third identified application 110 has a .png file with the same name, “img.png,” then this file can be accordingly renamed, such as to “img_{—}2.png.”

In one arrangement, the renaming of the resources can be based on a package index that is associated with a particular application. The package index can be, for example, a value that is assigned to the identified applications 110 at the time the applications 110 are selected for inclusion in the PIM. The selection of the values for the package index can be successive in nature, and a priority may or may not be a factor in assigning these values. For example, the first identified application 110 mentioned above may have a package index with a value of 0, and the file names of the resources of this application may remain unchanged. The resources of the second identified application 110, which may have a package index with a value of 1, may be renamed to include this value if a conflict exists with the first identified application 110, as explained above. Similarly, the third identified application 110 can have a package index with a value of 2, and its conflicting resources can be renamed using this value. Although conflicting resources may be renamed by relying on the package index of an application, it must be understood that other methods may be employed for such renaming.

If any resources of an application are renamed, then steps can be taken to ensure that the operation of the affected application is not interrupted. For example, the conflicts engine 125 or some other component can scan the source code of the affected application for references to the renamed resource. Once identified, these references may be changed to accommodate for the renamed resource.

There may be other steps taken to resolve conflicts among the identified applications 110. For example, some of the identified applications 110 may include the same code once they have been converted into secure applications, a process explained above. In view of the identified applications 110 eventually being combined into a single binary file, it may be redundant to have multiple copies of this code. Because these files may have been added earlier when the identified applications 110 were converted into secure applications, the files can be detected relatively easy in the applications 110 and then compared to ensure that they are identical. If there is a match, then one or more of the redundant copies of this common code may be deleted. If, however, there differences between the files, then they can be kept in their respective applications 110.

Referring back to method 200 of FIG. 2, at step 220, process tags can be attached to the components of the identified applications, and the identified applications can be packaged as a single binary file.

For example, for an identified application 110, the process engine 130 can read the manifest file (or some other content listing file) and can determine the process tag for that particular application 110. A process tag can indicate in which process a particular piece of software should run when that software is instantiated. The process engine 130 can then add this process tag to the components of the application. In one particular embodiment, process tags can be attached to each of the components of the application. Non-limiting examples of the components of an application include activities, services, content providers and broadcast receivers. Through this step, it can be ensured that each of the components of the application 110 may run in this particular process, and code from one application 110 can be prevented from running on a process that is designated for another application 110. This step can be performed for each of the identified applications 110, which can maintain per process sandboxing for the identified applications 110. Thus, if a problem develops with one application 110 of the PIM, such an issue should not spread to other applications 110 of the PIM.

In another embodiment, some identified applications 110 may have a main process and a sub-process that is similar to the main process. To accommodate this scenario, a process tag may be added to the sub-process tag, which can cause the component associated with the sub-process to run within the process associated with that particular identified application 110, thereby maintaining the per process sandboxing described above.

It is understood that some processes may run multiple applications. It is important to note that the step of adding the process tags to the components of the identified applications 110 will not interfere with this arrangement, as the relevant process may continue to run multiple applications 110 once they have been combined into the single binary file. Even so, the techniques recited here may prevent the components from running in an unauthorized process.

Once the conflicts have been resolved and the process tags have been added, the compiler 135 can package the identified applications 110 as a single binary file. The binary file can serve as a PIM, including a secure PIM. As part of this process, a resource file can be generated for the binary file to account for the renaming of the resources, and a manifest file can be generated for the binary file to identify the components and group them together according to their assigned processes. In addition, the compiler 135 can convert the binary file into a format that is acceptable for the computing device 105, such as a .dex file, and the file can be delivered to the computing device 105.

Combining the identified applications 110 into a single binary file improves distribution and maintenance efficiencies, in comparison to the individual allocation of the applications 110. In addition, the binary file can be treated like a normal or conventional application, meaning that it may be signed, installed and offered at an application store. Additional applications may be identified and added to the binary file as desired, in accordance with the discussion above.

Once received at the computing device 105, the PIM (i.e., binary file) may be installed, and the operating system (OS) of the device 105 may treat the PIM as a single application but as one that has multiple processes in which it may run. As an example, the PIM may have an application that serves as a launcher, and when initiated, those components that have process tags that are associated with the launcher's process may run. If another application in the PIM is launched, such as a contacts application, then a new process that is associated with the contacts application will start. The components of the contacts application, because they have been assigned the proper process tags, may run in the process of the contacts application. Thus, per process sandboxing can be maintained on the computing device 105.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method for combining multiple applications into a single binary file while maintaining per process sandboxing, comprising:
identifying a plurality of applications to be part of the single binary file;
analyzing the non-code assets of the identified applications for conflicts;
resolving the conflicts among the non-code assets of the identified applications;
attaching process tags to the components of the identified applications to ensure that the components of the identified application run in their authorized processes, thereby maintaining per process sandboxing of the identified applications; and
packaging the plurality of identified applications as the single binary file without affecting the per process sandboxing.

2. The method according to claim 1, wherein the single binary file is a secure personal information manager application.

3. The method according to 1, wherein resolving the conflicts among the non-code assets of the identified applications comprises renaming resources of the identified applications that present the conflicts.

4. The method according to claim 3, wherein renaming the resources of the identified applications that present the conflicts comprises renaming the resources based on a package index that is assigned to the identified applications.

5. The method according to claim 3, further comprising:
scanning the identified applications for references to the renamed resources; and
modifying the references to the renamed resources to account for the renaming of the resources.

6. The method according to claim 1, further comprising:
determining whether the identified applications of the single binary file contain code that is common to more than one of the identified applications; and
deleting the code that is common to the identified applications of the single binary file.

7. The method according to claim 1, further comprising:
distributing the single binary file to one or more computing devices such that an operating system of the computing device treats the single binary file as a single application that supports multiple processes; or distributing the single binary file to an application repository such that the single binary file is uploaded to the application repository as a single application.

8. A method of creating a personal information manager application, comprising:
identifying a plurality of applications to be part of the personal information manager application; and
packaging the identified applications as a single binary file that serves as the personal information manager application while maintaining per process sandboxing of the identified applications.

9. The method according to claim 8, further comprising:
analyzing the identified application for conflicts; and
resolving the conflicts between the identified applications.

10. The method according to claim 8, further comprising attaching process tags to the components of the identified applications to ensure that the components of the identified applications run in their authorized processes.

11. The method according to claim 8, wherein the personal information manager application is a secure personal information manager application and non-secure applications are restricted from accessing the secure personal information manager application.

12. The method according to claim 11, wherein the identified applications that are to be part of the personal information manager application are secure applications.

13. The method according to claim 10, further comprising decompiling the identified applications to enable the analyzing of the identified applications, the resolving of the conflicts and the attachment of the process tags of the components of the identified applications.

14. The method according to claim 10, wherein attaching the process tags to the components of the identified applications avoids interference with any processes that may run a plurality of the identified applications of the single binary file.

15. A system for combining multiple applications into a single binary file while maintaining per process sandboxing, comprising:
an input mechanism that is configured to receive the identities of multiple applications;
a conflicts engine that is configured to resolve conflicts the identified applications;
a process engine that is configured to assign process tags to the components of the identified applications such that the components of the identified applications run in their authorized processes; and
a compiler that is configured for packaging the identified applications as a single binary file without affecting the per process sandboxing.

16. The system according to claim 15, wherein the single binary file is a personal information manager application.

17. The system according to claim 16, wherein the personal information manager application is a secure personal information manager application and non-secure applications are restricted from accessing the secure personal information manager application.

18. The system according to claim 15, wherein the compiler is further configured to generate a resource file for the single binary file to account for the conflict resolution.

19. The system according to claim 15, wherein the compiler is further configured to generate a manifest file for the single binary file to identify the components of the single binary file and to group the components together according to the assigned processes of the components.

20. The system according to claim 15, wherein the conflicts engine is further configured to resolve conflicts among non-code assets of the identified applications.
